(19) United States
(12) Patent Application Publication
(10) Pub. No.: US 2021/0253346 A1
(43) Pub. Date: Aug. 19, 2021

(54) REINFORCED LID ASSEMBLY FOR A WASTE BIN

(71) Applicant: MGB RENTALS PTY LTD, Glenelg (AU)

(72) Inventors: Matthew James Norman Ramm, Black Forest (AU); Paul John Heitmann, Black Forest (AU); Michael John Brixton, Green Fields (AU)

(73) Assignee: MGB RENTALS PTY LTD, Glenelg (AU)

(21) Appl. No.: 17/059,867

(22) PCT Filed: May 28, 2019
(86) PCT No.: PCT/AU2019/050525

§ 371 Date: Nov. 30, 2020

(30) Foreign Application Priority Data
May 30, 2018 (AU) 2018901921

(51) Int. Cl. B65F 1/16; B65F 1/02; B65F 1/14

(52) U.S. Cl. CPC B65F 1/1623; B65F 1/1646; B65F 1/02; B65F 1/1452; B65F 2210/1125; B65F 2250/114; B65F 2210/1443; B65F 2250/1143; B65F 2210/138; B65F 2250/1146; B65F 2210/168

(57) ABSTRACT

A lid assembly for hinged connection to a bin body with an open top, the lid assembly including a lid formed as a single layer of polymer dimensioned to cover the open top, and a reinforcing frame for attachment to a hinge at a rear edge of the open top, the reinforcing frame having reinforcing members extending from the hinge towards a front edge of the lid extending along a front edge of the open top when the lid is in a closed position, wherein the reinforcing members attach to the lid for rotating therewith about the hinge.

### TECHNICAL FIELD OF THE INVENTION

The present invention relates to the hinged lids of large-scale waste and refuse bins, such as those generally referred to in Australia as mobile garbage bins (or MGBs). Specifically the invention relates to reinforced lid assemblies for those bins. Such bins usually have either two or four wheels, with volumes typically between 240 and 4,500 litres, with the smaller bins usually having a single lid and the larger bins having either a single lid or dual lids.

### BACKGROUND OF THE INVENTION

While smaller bins are able to utilise just a single, reasonably sized and weighted lid, larger bins tend to use a dual lid arrangement due to the typical weight of a single lid for a large bin being difficult to open and close. It has been found that the lids are often propped open for long periods of time, so as to avoid repeatedly raising and lowering a heavy lid. Alternatively a complex opening and closing mechanism is required, adding cost to the bin/lid arrangement and introducing dangerous pinch points for the user. Also, these bins tend to be treated quite roughly in use, so the adoption of complex opening and closing mechanisms, particularly if they are exposed outside the bin, tends to leave those mechanisms readily subject to damage and the need for repair.

To lessen the weight and awkwardness of a large, single lid, and reduce the need for complex opening mechanisms, dual lids may be used. However, there tends to be a gap between the two lids that allows rainwater to enter the bin, adding weight to the interior of the bin and saturating the content of the bin. Since the cost of waste disposal is usually calculated by weight, waste companies are keen to minimise the ingress of water to these bins.

In light of these issues, it would be beneficial to develop a rigid bin lid with a cost effective but light-weight construction that allows for a single lid to cover the open top of a large bin. It would be advantageous if the construction of the lid is well suited to high volume production techniques.

Any reference herein to a patent document or other matter which is given as prior art is not to be taken as an admission that that document or matter was known or that the information it contains was part of the common general knowledge as at the priority date of any of the claims.

### SUMMARY OF THE INVENTION

The present invention provides a lid assembly for hinged connection to a bin body with an open top, the lid assembly including a lid formed as a single layer of polymer dimensioned to cover the open top, and a reinforcing frame for attachment to a hinge at a rear edge of the open top, the reinforcing frame having reinforcing members extending from the hinge towards a front edge of the lid that sits adjacent a front edge of the open top when the lid is in a closed position, wherein the reinforcing members attach to the lid for rotating therewith about the hinge.

A lid assembly with a single layer of polymer (referred to as a ‘single skin’ by workers in this field), together with a reinforcing frame, provides a lighter weight construction than the usual dual skin construction, while remaining cost effective to produce. A dual skin lid is typically produced with a roto-moulding process that uses more polymer material and has a lower production rate than a single skin lid from an injection moulding process. The dual skin is structurally stiffer than a single skin but the added weight, particularly in larger bins, has the problems discussed above.

In a preferred form, the lid assembly also has a biasing means urging the lid toward an open position. It is further preferred for the biasing means to be configured to apply a biasing force that does not prevent the lid from falling to the closed positon under gravity. The biasing means may have at least one coil spring positioned such that a central coil axis of the coil spring is aligned with the hinge axis for the lid, and one end of the coil spring bears against the bin body while the other end bears against the lid.

The reinforcing frame may have spaced reinforcing bars extending from the hinge axis towards the front edge of the lid, and an elongate member fixed to each of the reinforcing bars, the elongate member extending parallel to the hinge axis such that the reinforcing bars all rotate in unison about the hinge axis when opening and closing the lid. The elongate member may be a hinge tube for rotatable mounting to the bin body such that the hinge axis for the lid is co-linear with the longitudinal axis of the hinge tube. Advantageously, the reinforcing bars are dimensioned to extend more than half way from the hinge axis to the front edge of the lid. It is also preferable that the lid has integrally formed recesses for receiving each of the reinforcing bars respectively with a sliding fit. In a still further preferred form, the lid has integrally formed rib formations to increase bending stiffness, at least some of the rib formations being partially formed by the integrally formed recesses.

In one form, the lid assembly may further include a coloured panel detachably secured to the lid, the coloured panel providing a visual indication of a type of waste stream intended for the bin. In a further preferred form, the coloured panel has electronic circuitry for at least one of locating the bin, identifying the bin, identifying the intended waste stream, logging waste collection time, and/or sensing content levels within the bin.

Preferably the lid is an injection moulded, unitary polymer component. Optionally, the polymer will be any one of polyurethane, polypropylene, polyethylene, polystyrene, acrylonitrile butadiene styrene, polycarbonate, polyester, polyvinyl chloride, or polyamide.

Preferably the open top area is between 1 and 5 m² and the lid is less than 50 kg in weight.

In another aspect, the invention provides a method of closing an open top of a bin body, the method including:

injection moulding a lid as a single layer, polymer component dimensioned to cover the open top;

providing a reinforcing frame for hinged connection to a rear edge of the open top, the reinforcing frame having spaced reinforcing elements for engagement with the lid; and

attaching the reinforcing frame to the rear edge, such that applying a lifting force to a front edge of the lid, rotates the lid together with the reinforcing elements about the rear edge towards an open position.

The method may also include the step of incorporating a biasing means to bias the lid towards the open position, wherein the bias is such that the lid will still fall under gravity to a closed position covering the open top.

The method may also include the step of detachably securing a colour panel to the lid to provide a visual indication of a type of waste stream intended for the bin. In this respect, the panel may be provided with electronic circuitry configured for one or more of locating the bin, identifying the bin, identifying the intended waste stream, logging waste collection time, and/or sensing content levels within the bin.

A related aspect of the invention provides a hinge system for a waste bin, the waste bin having a bin body with an open top and a lid for covering at least some of the open top, the system including a hinge assembly for hinging the lid to the bin body adjacent the open top, such that the lid is rotatable between a closed position at least partially covering the open top and an open position exposing the open top, and a damper assembly for connection to the bin body and the lid, the damper assembly having a damping mechanism configured for generating resistance to movement of the lid towards the closed position and substantially less resistance to movement of the lid towards the open position.

In this related aspect, the damping mechanism may be configured to contain fluid and defines at least one flow path such that movement of the lid towards the open or the closed positions generates fluid flow along the at least one flow path, the fluid flow rate when the lid is moving towards the open position being substantially higher than the fluid flow rate when the lid is moving towards the closed position. Preferably, the damping mechanism has two flow paths, one being a high flow rate path for the fluid flow generated by moving the lid towards the open position, and the other being a low flow rate path for the fluid flow generated by moving the lid to the closed position. Preferably, the high flow rate path and the low flow rate path each have a one way valve to allow fluid flow in one direction only.

In one form, the damping mechanism may have a fluid chamber for holding the fluid, and a vane configured for movement within the fluid chamber in response to moving the lid towards the open or closed positions, the high flow rate path and the low flow rate path being formed in the vane such that the flow direction through the high flow rate path is opposite that of the low flow rate path.

Optionally the damping mechanism will have one fluid flow path and a valve configured for a first fluid flow rate in one direction along the path and a second fluid flow rate for flow in an opposing direction, wherein the first fluid flow rate is substantially more than the second fluid flow rate. In one form, the valve is a flap valve with a flap that opens for the first fluid flow rate, and closes for the second fluid flow rate in the opposing direction, the flap having an aperture that allows the second fluid flow rate in the opposing direction. Preferably, the aperture is adjustable to vary the second fluid flow rate.

The damping mechanism may have a pressure relief valve configured to open in response to fluid pressure in the fluid chamber exceeding a predetermined maximum.

Preferably the fluid chamber has a volume divided by the vane configured to seal against an interior surface within the volume and sweep through the volume in response to hinged movement of the lid relative to the bin body, such that movement of the vane generates the fluid flow. The pressure relief valve may have a valve inlet, a valve outlet and valve member biased into sealed engagement with a valve seat such that the valve member is unseated against the bias in response to fluid pressure exceeding the predetermined maximum at the valve inlet. Preferably, the valve inlet is in fluid communication with a high pressure side of the vane when the lid is moving towards the closed position and the valve outlet is in fluid communication with a low pressure side of the vane when the lid is moving towards the closed position. Preferably, the bias urging the valve member into sealing engagement with the valve seat is adjustable to thereby vary the predetermined maximum fluid pressure.

The fluid chamber will ideally contain liquid polymerised siloxane (silicone oil). The liquid polymerised siloxane may be polydimethylsiloxane (PDMS).

### BRIEF DESCRIPTION OF THE DRAWINGS

Preferred embodiments of the present invention will now be described by way of example only, with reference to the accompanying figures, in which:

FIG. 1 is a perspective view of a waste bin according to the invention with the lid in the closed position;

FIG. 2 is a front perspective view of the waste bin of FIG. 1 with the lid raised to the open position;

FIG. 3 is a rear perspective view of the waste bin of FIG. 1 showing the damper assembly and coil springs of the hinge system;

FIG. 4 is a top perspective of the plastic bin lid shown in isolation;

FIG. 5 is a bottom perspective of the plastic bin lid shown in isolation;

FIG. 6 is a perspective of the hinge assembly shown in isolation;

FIG. 7 is an enlarged perspective of the damper assembly from the hinge assembly shown in FIG. 6;

FIG. 8 is a perspective of the elongate hinge bar and lid reinforcing bars from the hinge assembly shown in isolation;

FIG. 9 is an enlarged perspective of the damping mechanism shown in isolation;

FIG. 10 is a sectioned perspective of the damping mechanism shown in FIG. 9;

FIG. 11 is an end view of the damping mechanism shown in isolation;

FIG. 12 is a cross section through Section A-A shown in FIG. 11; and

FIG. 13 is a vertical cross section through the hinge axis of the waste bin.

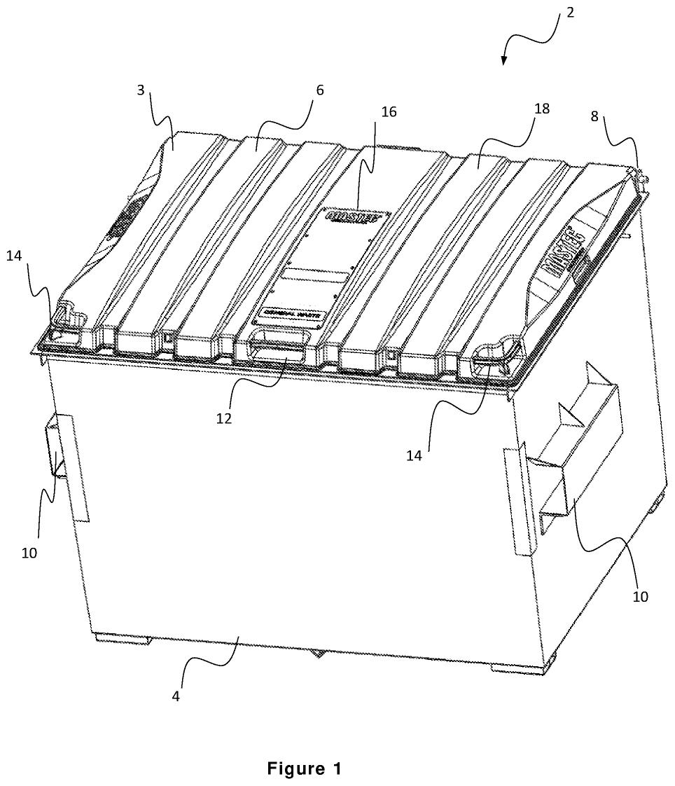

### DETAILED DESCRIPTION OF PREFERRED EMBODIMENT

Referring to the Figures, the waste bin 2 has a steel bin body 4 with a lid assembly 3. The lid assembly 3 has a polymer lid 6 dimensioned to cover the open top 20. The lid assembly 3 also has a reinforcing frame 5 that hinges to the bin body 4 adjacent a rear edge of the open top 20 via a hinge assembly 8. The reinforcing frame structurally stiffens the lid 6, such that it does not overly flex and deform when lifted. A damping assembly 24 within the hinge assembly 8 holds the lid open long enough to deposit rubbish before slowly closing.

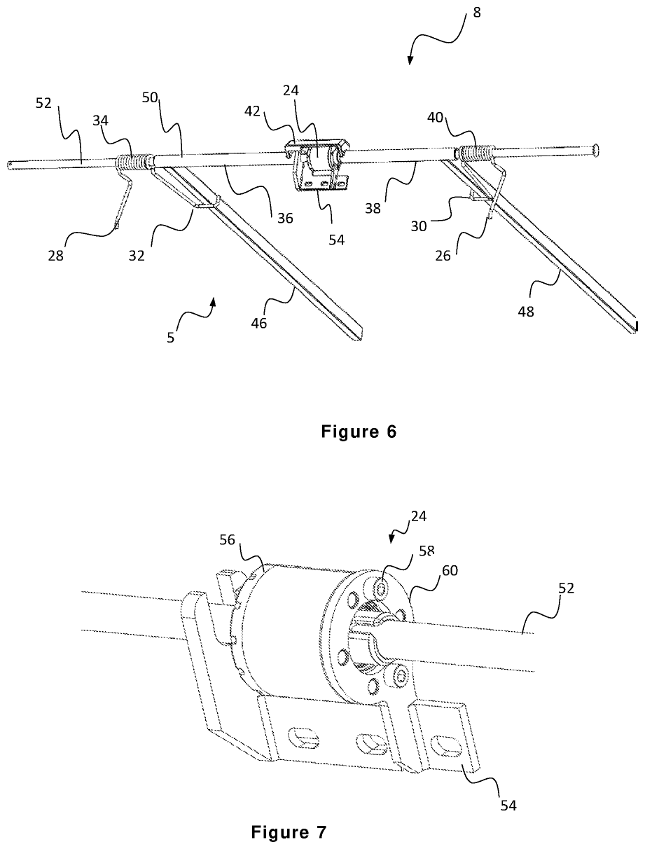

The hinge assembly 8 extends along the rear edge of the open top 20, while the front edge of the lid 6 has an integrally moulded centre handle 12 and front corner handles 14 on either side. The open top 20 of the bin body 4 is a relatively broad area for the lid to cover and integrally formed ribs 18 provide some additional rigidity. However, the lids 6 require additional stiffness and have traditionally been a dual layer polymer construction formed in a roto-moulding process. Reducing this construction to a single layer, injection moulded construction is lighter, and uses less polymer material for significant production cost benefits. Reinforcing bars 46 and 48 (see FIG. 6) provided by the reinforcing frame 5 avoids excessive bending or flexing of the thinner lid 6 when lifted using the centre handle 12 or either of the corner handles 14.

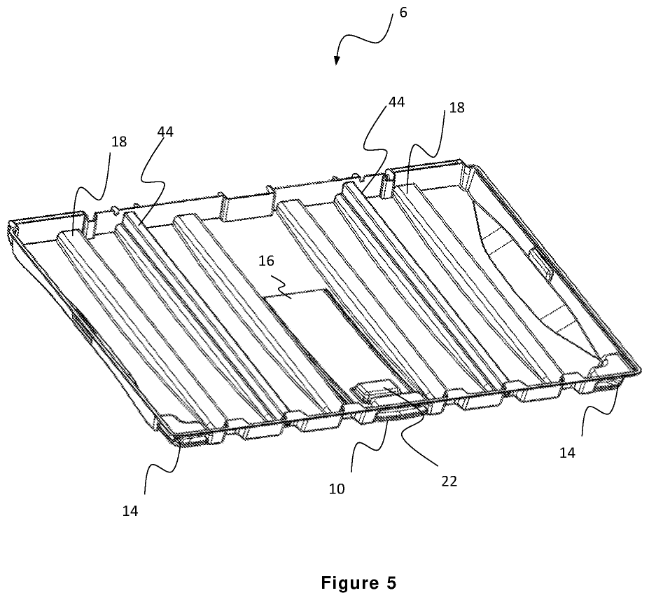

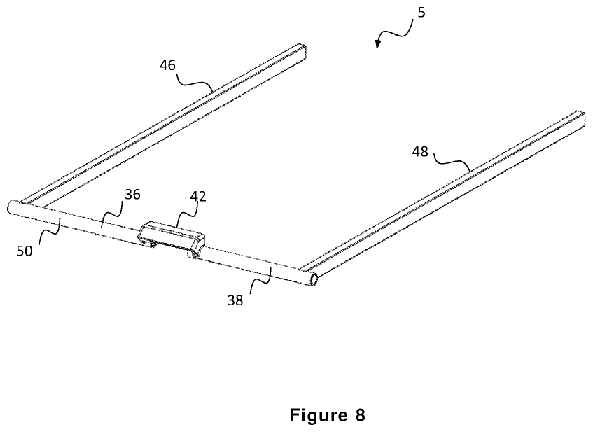

Referring to FIG. 8, the reinforcing frame 5 has reinforcing elements in the form of a pair of spaced reinforcing bars 46 and 48 welded (or otherwise fixed) to the hinge tube 50. The reinforcing bars 46, 48 are dimensioned for a sliding fit into complementary sleeves 44 integrally formed in the underside of the lid 6 (see FIG. 5). The reinforcing bars 46, 48 do not need to extend all the way to the front edge of the lid 6 but should extend across the majority of the lid (i.e. at least halfway across the lid). Lifting the lid 6 from the front edge, say the corner handle 14, transfers the lifting force to one of the reinforcing bars (say 46) more than the other (48) because of the flex in the relatively thin ‘single skin’ of polymer. Here the sleeve 44 transfers the lift force to the reinforcing bar 46 in a distributed manner along its length.

In turn, the reinforcing bar 46 applies torque to the hinge tube 50 which rotates the other reinforcing bar 48 upwards in unison. The other reinforcing bar 48 also acts along the length of its sleeve 44 in the lid 6 to further distribute the lifting force. With the lifting force on the corner handle 14 being distributed by the reinforcing frame 5, the amount of flex across the expanse of the lid 6 is restricted despite being relatively thin.

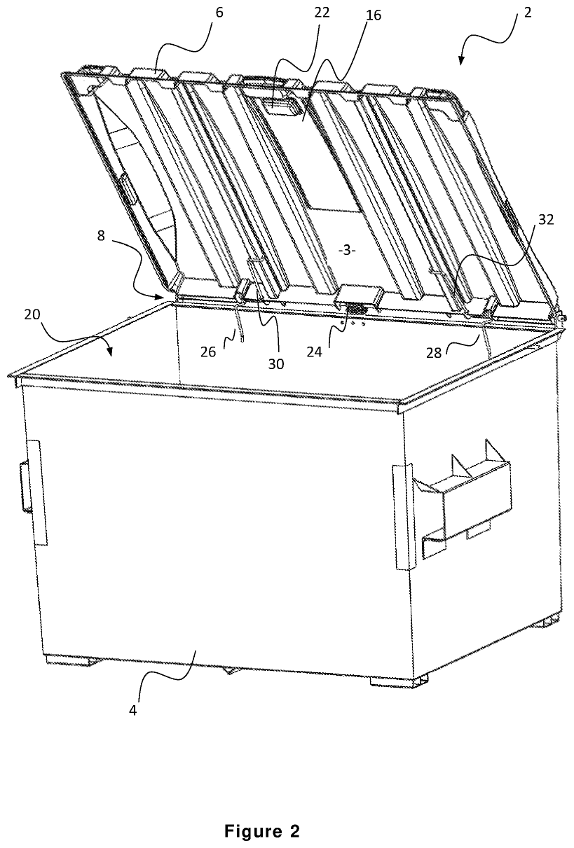

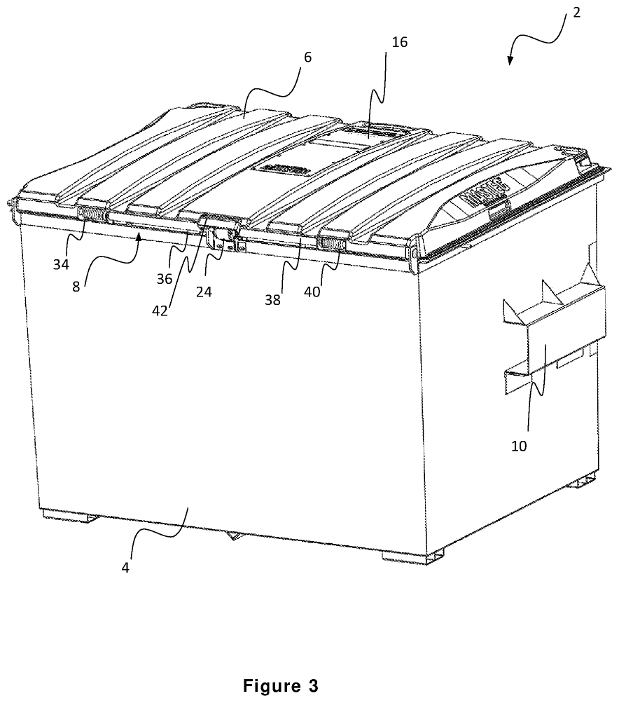

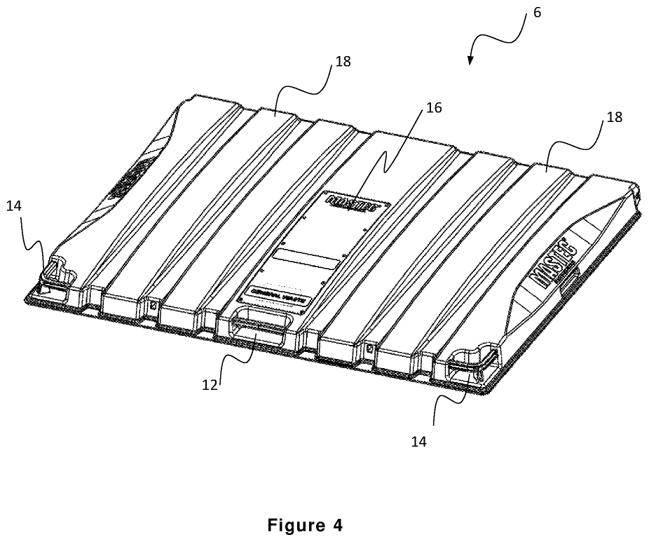

To assist the user, the lid assembly 3 is provided with a biasing mechanism in the form of a pair of coil springs 34 and 40. The coil springs are in a state of residual torque when the lid 6 is in the closed position to provide lift assistance when opening the lid. One end of each of the springs 26 and 28 bears against the bin body 4, while the opposing ends 30 and 32 bear on the reinforcing elements 48 and 46 respectively, on the underside of the lid 6 (see FIG. 2).

The lid assembly 3 has a detachable central panel 16 coloured to indicate the type of refuse designated for the bin 2. Typically, bins are designated for different types of recyclable waste as well as general waste for landfill. Using a single, central panel 16 that is retrofitted to the lid 6, allows the lids to be produced in a single colour only, which is more efficient for manufacturing and warehousing of stock.

Beneath the central panel 16 is electronic circuitry 22 that can be used to track and/or identify the bin 2, or identify the type of waste stream designated to the bin, log the time and date of waste collections and/or sense the bin content levels.

The waste bin 2 is of the front lift type, meaning garbage trucks lift the bin 2 from the front when emptying its contents. Two hydraulically driven front tynes on the garbage truck are inserted into the channels 10 on each side of the bin body 4. The bin is lifted up and over the cabin of the truck, then inverted so the contents fall under gravity into the back of the truck. To allow the contents of the bin to fall freely out of the bin body 4, the lid 6 needs to fall open quickly. Similarly, when users are lifting the lid 6 to deposit rubbish, the weight of the lid or the hinge mechanism should not make the opening process overly strenuous or time consuming. However, having opened the lid 6, the user will often require two hands to then lift the load of refuse up and into the open top 20 of the bin body 4. To accommodate this, many prior art bins provide a strut at one or both sides of the lid to prop it open for the user.

Unfortunately, there is a tendency to forget about disengaging the struts and the lid remains propped open. Furthermore, keeping the lid open is often more convenient for the user when disposing of the next load of refuse. Unfortunately, the contents of the bin 2 are exposed to the elements while the lid is open and rain can saturate the refuse. This increases the weight of the refuse, which in turn increases the cost of waste disposal (which is typically calculated on the basis of weight).

As best shown in FIGS. 6 and 7, the hinge system uses a damper assembly 24 connected to the bin body 4 and the lid 6 to generate resistance to movement of the lid towards the closed position, but little or no resistance to movement of the lid towards the open position. In this way, the user may lift the lid 6 without undue effort and then has ample time to manually lift and deposit the refuse through the open top 20, as the lid 6 slowly falls back to the closed position under gravity. This removes the need to engage any side props or struts to hold the lid open, or subsequently disengage them after disposing of the refuse. With the lid 6 automatically closing (albeit slowly) under its own weight, the contents of the bin are not exposed to the weather for prolonged periods.

The damper assembly 24 connects to the lid 6 via the bars 46 and 48 of the reinforcing frame. These bars are inserted into integrally moulded channels 44 in the underside of the lid 6 (see FIG. 5). The lid reinforcing bars 46 and 48 are fixed to the hinge tube 50, which in turn are fixed to the elongate hinge axle 52 of the hinge assembly 8. The longitudinal axis of the hinge axle 52 defines the hinge axis 64 for the lid (see FIG. 10).

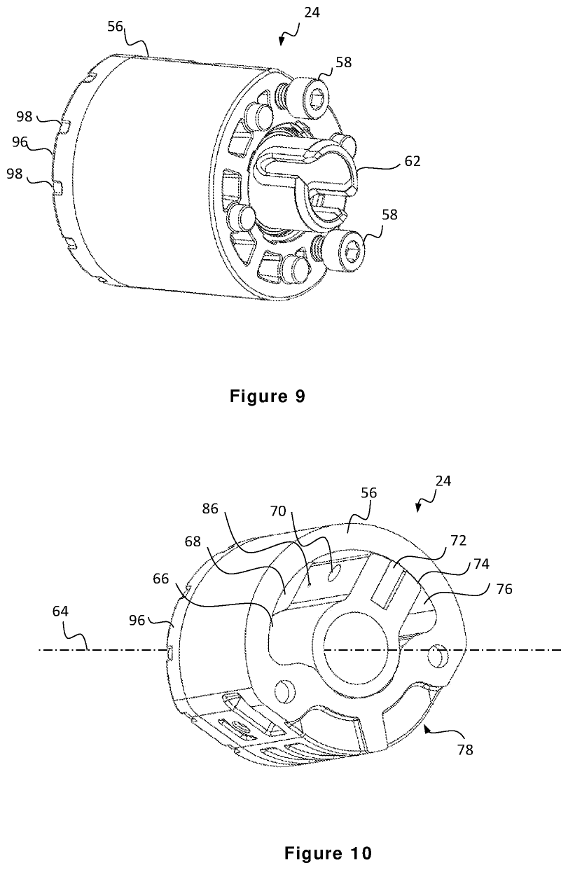

As best shown in FIG. 8, the hinge tube 50 of the reinforcing frame 5 is provided in two sections 36 and 38 connected by a travel stop surface 42. Referring back to FIG. 6, a damper assembly 24 sits beneath the travel stop surface 42 mounted on the hinge axel 52 and connects the inner ends of the tube sections 36 and 38. As best shown in FIGS. 7, 9 and 10, the inner ends of sections 36 and 38 are fixed to the central hub 62 of the damper assembly 24. The central hub 62 is integrally formed with a rotating vane 74. The rotating vane 74 moves within the fluid chamber 66 defined by the outer housing 56 of the damper assembly 24.

The fluid within the fluid chamber 66 may be any suitable liquid or gas. One particularly suitable fluid is liquid polymerised siloxane (silicone oil), such as polydimethylsiloxane (PDMS). This has a viscosity that does not vary greatly with temperature and therefore the damping response, and ultimately the closure rate of the lid is relatively constant despite changes in ambient temperature.

Lifting the lid 6 to the open position rotates the hinge tube 50, which in turn rotates the hinge axle 52. As a result, the internal vane 74 sweeps through the fluid chamber 66 with the rotation of the central hub 62. The silicone oil on one side 68 of the vane 74 is forced through a relatively large one-way valve 70 defining a flow path to the other side 76 of the vane 74. A much smaller one-way valve 86 remains closed against flow in that direction. A compressible vane seal 72 minimises leakage between the first side 68 and the second side 76 of the fluid chamber 66, but the flow rate through the larger valve 70 is such that it does not create and significant resistance to moving the lid to the open position. Conversely, as the lid falls shut, the silicon oil flows through the smaller one-way valve 86 in the other direction while the larger valve 70 closes. The lower flow rate slows the descent of the lid 6 allowing the user time to manually lift and deposit bags of refuse into the bin body 4.

In one alternative, the valve 70 is configured to allow a much higher flow rate of the silicone oil in one direction along the flow path relative to the flow rate in the opposite direction. The skilled worker will realise that this may be provided in many different forms but a simple implementation involves a flap valve with a carefully dimensioned aperture within the flap to govern the constricted flow rate of silicone oil through the valve as the lid 6 falls shut. Fluid flow in the ‘lid-opening’ direction simply opens the flap and there is little or no resistance to rotating the vane 74 within the fluid chamber 66 (when opening the lid). This variation of the damper mechanism 24 would not require the second relatively small one-way valve 86.

Skilled workers will also understand that such valves 70 are often provided with the ability for manual adjustment such that the aperture is changed to vary the constricted flow rate. Of course, this in turn adjusts the level of damping as the lid falls shut.

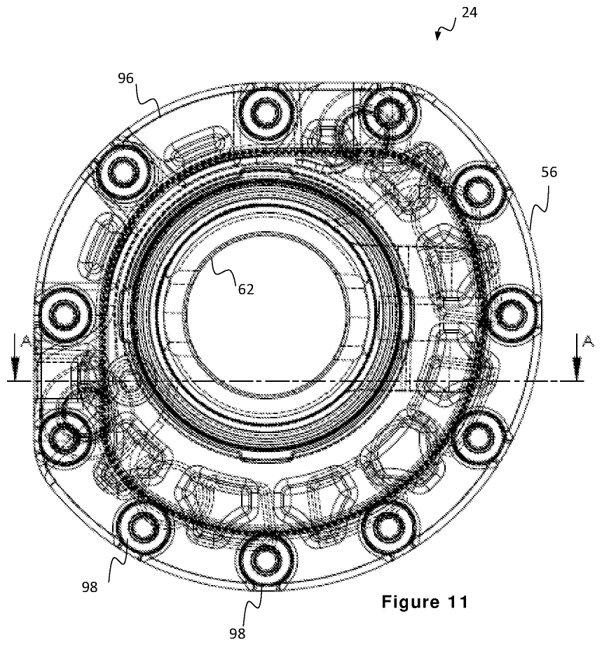

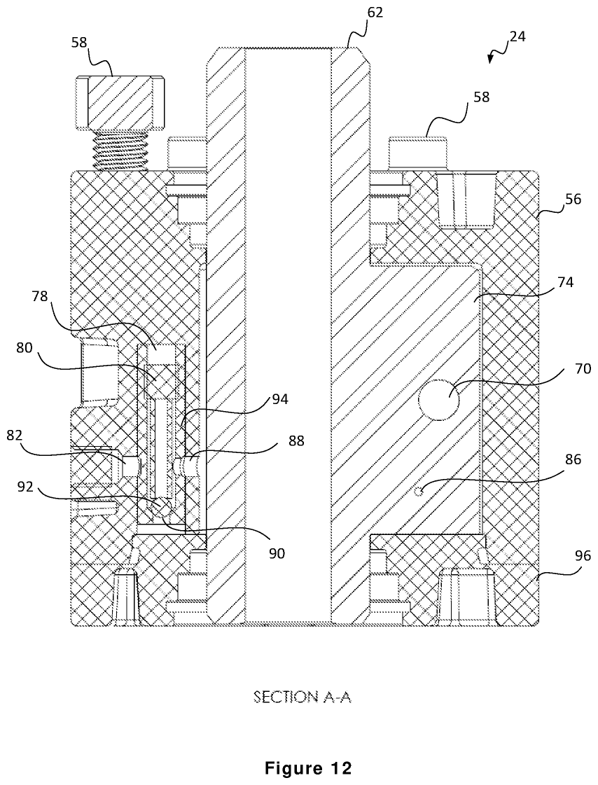

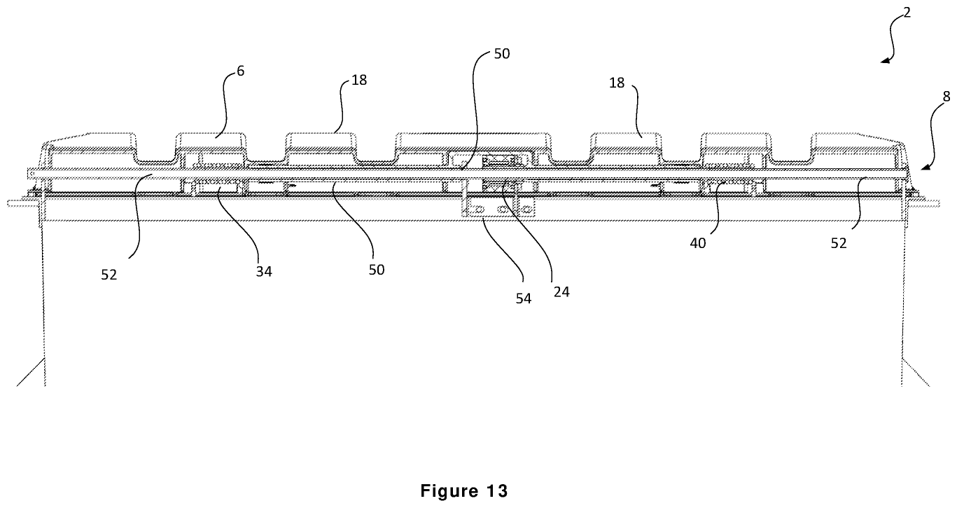

Referring to FIGS. 11 and 12, the damping mechanism 24 also incorporates a pressure relief valve 78 configured to open in response to the fluid pressure of silicone oil exceeding a predetermined maximum. This avoids damage to the damping mechanism if the lid is forced back to the closed position at a rate that generates pressure levels which could damage the valves 70 and/or 86, or compromise the fluid seal provided by the compression bolts 98 about the periphery of the end plate 96. The pressure relief valve 78 has a tubular valve body 94 defining a valve seat for sealing engagement with a valve member in the form of a ball 92. A biasing mechanism 80 in the form of a threaded boss engages a complementary internal thread within the bore of the valve body 94. The boss compresses a coil spring within the bore to urge the ball 92 against the valve seat. The valve inlet 90 is in fluid communication with the high pressure side of the vane 74 when the lid 6 is moving towards the closed position. The valve outlet 88 is in fluid communication with the low pressure side of the vane 74 when the lid 6 is closing. At the maximum pressure, the pressure difference across the ball 92 exceeds the bias of the spring to open the valve and allow oil from the high pressure side to vent to the low pressure side.

The mounting plate 54 connecting the damping assembly 24 to the bin body 4 is configured to abut the travel stop surface 42 to limit to the angular travel of the lid. In this way, the lid 6 is restricted as to how far it can open such that it will always be at an angle where it will fall shut under gravity (assuming the bin 2 rests on a roughly horizontal surface).

The invention has been described herein by way of example only. Skilled workers in this field will readily recognise many variations and modifications which do not depart from the spirit and scope of the broad inventive concept.

1. A lid assembly for hinged connection to a bin body with an open top, the lid assembly including:
a lid formed as a single layer of polymer dimensioned to cover the open top; and
a reinforcing frame for attachment to a hinge at a rear edge of the open top, the reinforcing frame having reinforcing members extending from the hinge towards a front edge of the lid extending along a front edge of the open top when the lid is in a closed position;
wherein the reinforcing members attach to the lid for rotating therewith about the hinge.

2. A lid assembly according to claim 1, further including a biasing means urging the lid toward an open position.

3. A lid assembly according to claim 2, wherein the biasing means is configured to apply a biasing force that does not prevent the lid from falling to the closed position under gravity.

4. A lid assembly according to claim 3, wherein the biasing means has at least one coil spring positioned such that a central coil axis of the coil spring is aligned with the hinge axis for the lid, and one end of the coil spring bears against the bin body while the other end bears against the lid.

5. A lid assembly according to claim 1, wherein the reinforcing frame has spaced reinforcing bars extending from the hinge axis towards the front edge of the lid, and an elongate member fixed to each of the reinforcing bars, the elongate member extending parallel to the hinge axis such that the reinforcing bars all rotate in unison about the hinge axis when opening and closing the lid.

6. A lid assembly according to claim 5, wherein the elongate member is a hinge tube for rotatable mounting to the bin body such that the hinge axis for the lid is co-linear with the longitudinal axis of the hinge tube.

7. A lid assembly according to claim 5, wherein the reinforcing bars are dimensioned to extend more than half way from the hinge axis to the front edge of the lid.

8. A lid assembly according to claim 5, wherein the lid has integrally formed recesses for receiving each of the reinforcing bars respectively with a sliding fit.

9. A lid assembly according to claim 8, wherein the lid has integrally formed rib formations to increase bending stiffness, at least some of the rib formations being partially formed by the integrally formed recesses.

10. A lid assembly according to claim 1, further including a coloured panel detachably secured to the lid, the coloured panel providing a visual indication of a type of waste stream intended for the bin.

11. A lid assembly according to claim 10, wherein the coloured panel has electronic circuitry for at least one of locating the bin, identifying the bin, identifying the intended waste stream, logging waste collection time, and sensing content levels within the bin.

12. A lid assembly according to claim 1, wherein the lid is an injection moulded, unitary polymer component.

13. A lid assembly according to claim 12, wherein the polymer is any one of polyurethane, polypropylene, polyethylene, polystyrene, acrylonitrile butadiene styrene, polycarbonate, polyester, polyvinyl chloride, or polyamide.

14. A lid assembly according to claim 1, wherein the open top of the bin covered by the lid defines an area of more than 1 m².

15. A lid assembly according to claim 14, wherein the open top area is between 1 m² and 5 m² and the lid is less than 50 kg.

16. A waste bin including a bin body and a lid assembly according to claim 1.

17. A method of closing an open top of a bin body, the method including:
injection moulding a lid as a single layer, polymer component dimensioned to cover the open top;
providing a reinforcing frame for hinged connection to a rear edge of the open top, the reinforcing frame having spaced reinforcing elements for engagement with the lid; and
attaching the reinforcing frame to the rear edge, such that applying a lifting force to a front edge of the lid, rotates the lid together with the reinforcing elements about the rear edge towards an open position.

18. A method according to claim 17, further including the step of incorporating a biasing means to bias the lid towards the open position, wherein the bias is such that the lid will still fall under gravity to a closed position covering the open top.

19. A method according to claim 17, further including the step of detachably securing a colour panel to the lid to provide a visual indication of a type of waste stream intended for the bin.

20. A method according to claim 17, wherein the open top defines an area between 1 m² and 5 m², and the lid weighs less than 50 kg.

21. A method according to claim 17, further including detachably securing a panel to the lid wherein the panel provides a visual indication of a type of waste stream intended for the bin.

22. A method according to claim 21 further including providing the panel with electronic circuitry configured for one or more of locating the bin, identifying the bin, identifying the intended waste stream, logging waste collection time, and sensing content levels within the bin.
